(19) United States
(12) Patent Application Publication
(10) Pub. No.: US 2018/0007926 A1
(43) Pub. Date: Jan. 11, 2018

(54) SYSTEM AND METHOD OF COLD BREWING COFFEE

(71) Applicants: Sean Arroyo, Manassas, VA (US); Dominic DiGiovanni, Manassas, VA (US)

(72) Inventors: Sean Arroyo, Manassas, VA (US); Dominic DiGiovanni, Manassas, VA (US)

(21) Appl. No.: 15/207,032

(22) Filed: Jul. 11, 2016

(51) Int. Cl. A23F 5/26; A47J 31/46

(52) U.S. Cl. CPC A23F 5/26; A47J 31/467

(57) ABSTRACT

A cold brew coffee system and method is provided. The cold brew coffee system includes a liquid tank and an infusion tank. The liquid tank and the infusion tank each include an inlet and an outlet. The infusion tank may include a top filter and a bottom filter and contains coffee grinds therebetween. A first liquid line runs from the outlet of the fusion tank to the inlet of the liquid tank. A first pump pumps liquid from through the first liquid line from the infusion tank to the liquid tank. The outlet of the liquid tank delivers the liquid to the inlet of the infusion tank.

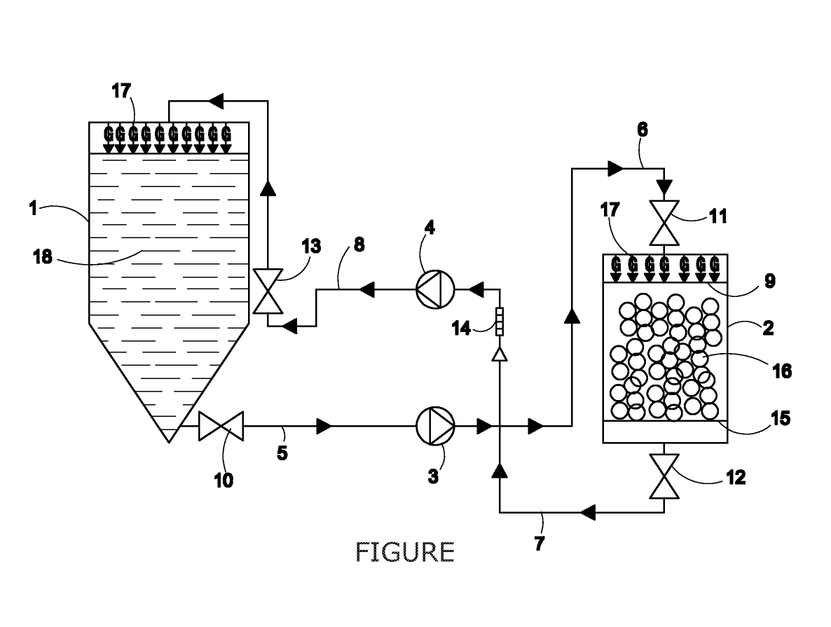

### BACKGROUND OF THE INVENTION

The present invention relates to brewing coffee and, more particularly, to a system and method of cold brewing coffee.

Cold brew, or cold water extract, refers to the process of steeping coffee grounds in room temperature or cold water for an extended period. Cold brew coffee is not to be confused with iced coffee, which generally refers to coffee that is brewed hot and then chilled by pouring over or adding ice, though iced coffee can refer to cold brew coffee served on ice. Current methods of cold brew coffee production have a high coffee to water ratio and the final product is oxidized. Further, most cold brew processes are inefficient at extracting coffee from roasted coffee beans.

As can be seen, there is a need for an improved system and method of cold brewing coffee.

### SUMMARY OF THE INVENTION

In one aspect of the present invention, a cold brew coffee system comprises: a liquid tank comprising an inlet and an outlet; an infusion tank comprising an inlet and an outlet and configured to contain coffee grinds in between the inlet and the outlet; a first liquid line running from the outlet of the infusion tank to the inlet of the of the liquid tank; and a first pump operable to pump a liquid through the first liquid line, wherein the outlet of the liquid tank is configured to deliver the liquid to the inlet of the infusion tank.

In another aspect of the present invention, a method of cold brewing coffee comprises: placing coffee grinds within an infusion tank; filling a liquid tank with liquid; directing the liquid from the liquid tank into the infusion tank; allow coffee grinds to steep within the infusion tank for a first period of time forming a liquid steep; circulating the liquid steep from the infusion tank into the liquid tank and from the liquid tank into the infusion tank for a second period of time.

These and other features, aspects and advantages of the present invention will become better understood with reference to the following drawings, description and claims.

### BRIEF DESCRIPTION OF THE DRAWINGS

The FIGURE is a schematic view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Referring to the Figure, the present invention includes a cold press coffee system utilizing pressurized tanks. The cold brew coffee system includes a liquid tank 1 and an infusion tank 2. The liquid tank 1 and the infusion tank 2 each include an inlet and an outlet. The infusion tank 2 may include a top filter 9 and a bottom filter 15 and contains coffee grinds 16 therebetween. A first liquid line 7, 8 runs from the outlet of the fusion tank 2 to the inlet of the liquid tank 1. A first pump 4 pumps liquid from through the first liquid line 7, 8 from the infusion tank 2 to the liquid tank 1. The outlet of the liquid tank 1 delivers the liquid to the inlet of the infusion tank 2.

In certain embodiments, the liquid tank 1 may deliver liquid to the infusion tank 2 via gravity. Alternatively, the present invention may utilize a second pump 3 and a second liquid line 5, 6. The second liquid line runs from the outlet of the liquid tank 1 to the inlet of the infusion tank 2. The second pump 3 pumps liquid from the liquid tank 1 to the infusion tank 2. It is also possible to connect multiple infusion tanks 2 to one liquid tank 1 which is determined by the size of the batch.

The first liquid line 7, 8 may include an infusion tank outlet hose 7 and a liquid tank inlet hose 8. The first pump 4 may be disposed in between and may pump liquid from the infusion tank outlet hose 7 into the liquid tank inlet hose 8. The second liquid line 5, 6 may include a liquid tank outlet hose 5 and an infusion tank inlet hose 6. The second pump 3 may be disposed in between and may pump liquid from the liquid tank outlet hose 5 into the infusion tank inlet hose 6. The infusion tank outlet hose 7 may include a first valve 12, the liquid tank inlet hose 8 may include a second valve 13, the liquid tank outlet hose 5 may include a third valve 10 and the infusion tank inlet hose 6 may include a fourth valve 11. A filter 14 may be disposed within the infusion tank outlet hose 7. The valves 10, 11, 12, 13 may each be a 1.5″ valve.

A method of using the above cold brew coffee system may include the following. Coffee grinds 16 may be placed in a mesh sack. The coffee grinds 16 are then placed within the infusion tank 2. The infusion tank 2 may be purged with an inert gas 17, such as nitrogen. The purging process removes oxygen from the system. The purging process may include the following. The inert gas tank is connected to the fourth valve 11 and the fourth valve 11 is opened. The infusion tank 2 is filled with nitrogen until pressure is around 15 psi. The fourth valve 11 is then closed. The first valve 12 is then opened, dropping the pressure to 0 and flushing the tank of nitrogen and oxygen. The above steps may be repeated two or three times. After the cycle has been repeated, the pressure within the infusion tank 2 is set to about 1 up to about 5 psi, or higher depending on desired extraction. The liquid tank 1, the first liquid line 7, 8, and the second liquid line 5, 6 may also be purged using the method described above.

The liquid tank 1 is filled with a liquid 18, such as water. The liquid 18 may run through the second valve 13 into the liquid tank 1. The head pressure within the liquid tank 1 is periodically reduced to allow water to easily flow into the liquid tank 1. Once filled with water, the second valve 13 is closed. The ratio between the coffee and the water in weight may be about 0.5:1 up to about 1:1, such as about 0.65:1. The liquid tank 1 head pressure is then set to about 10 psi, or higher depending on desired extraction by connecting the nitrogen gas container to the second valve 13 and filling the liquid tank 1 with nitrogen gas. The second valve 13 is then closed.

The third valve 10 and the fourth valve 11 are then opened. The liquid 18 is pumped from the liquid tank 1 through the second line 5, 6 and into the infusion tank 2. The infusion tank 2 is filled with the liquid and the second pump 3 is turned off. The coffee grinds 16 are steeped for a first period of time, such as about 10 minutes up to about 15 minutes. All valves 10, 11, 12, 13 are then opened and the pumps 3 and 4 are turned on. The second pump 3 may pump at a faster rate than the first pump 4. For example, the second pump 3 may be set about 5 up to about 10 rpms higher than the first pump 4. The liquid steep is circulated between the infusion tank 2 and the liquid tank 1. The system may be purged of air. For example, a port in the second valve 13 may be opened until a steady stream of liquid is exiting the port. The port is then closed. The cycle may run for a second period of times, such as about 8 up to about 24 hours.

After the second period of time has run out, the cycle is complete. The third valve 10 is closed and the second pump 3 is turned off. The infusion tank 2 is filled with nitrogen to about 15 psi, or higher depending on desired extraction. The first pump 4 remains on and the infusion tank 2 is drained under pressure, extracting the concentrated coffee from the saturated coffee grinds 16. Once the infusion tank 2 is empty, the second valve 13 is closed and the first pump 4 is turned off. The cold brew coffee is within the liquid tank 1 and the steep coffee grinds 16 are within the infusion tank 2. The liquid tank may then be purged.

It should be understood, of course, that the foregoing relates to exemplary embodiments of the invention and that modifications may be made without departing from the spirit and scope of the invention as set forth in the following claims.

What is claimed is:

1. A cold brew coffee system comprising:
a liquid tank comprising an inlet and an outlet;
an infusion tank comprising an inlet and an outlet and configured to contain coffee grinds;
a first liquid line running from the outlet of the infusion tank to the inlet of the of the liquid tank; and
a first pump operable to pump a liquid through the first liquid line, wherein
the outlet of the liquid tank is configured to deliver the liquid to the inlet of the infusion tank.

2. The cold brew coffee system of claim 1, further comprising a second liquid line running from the outlet of the liquid tank to the inlet of the infusion tank.

3. The cold brew coffee system of claim 2, further comprising a second pump operable to pump the liquid through the second liquid line.

4. The cold brew coffee system of claim 1, wherein the first liquid line comprises an infusion tank outlet hose and a liquid tank inlet hose, wherein the first pump is disposed therebetween.

5. The cold brew coffee system of claim 4, wherein the infusion tank outlet hose comprises a first valve and the liquid tank inlet hose comprises a second valve.

6. The cold brew coffee system of claim 5, wherein the second liquid line comprises a liquid tank outlet hose and an infusion tank inlet hose, wherein the second pump is disposed therebetween.

7. The cold brew coffee system of claim 6, wherein the liquid tank outlet hose comprises a third valve and the infusion tank inlet hose comprises a fourth valve.

8. The cold brew coffee system of claim 1, further comprising a filter disposed within the first liquid line.

9. A method of cold brewing coffee comprising:
placing coffee grinds within an infusion tank;
filling a liquid tank with liquid;
directing the liquid from the liquid tank into the infusion tank;
allow coffee grinds to steep within the infusion tank for a first period of time forming a liquid steep;
circulating the liquid steep from the infusion tank into the liquid tank and from the liquid tank into the infusion tank for a second period of time.

10. The method of claim 9, wherein a first liquid line runs from an outlet of the infusion tank to an inlet of the liquid tank and a second liquid line runs from an outlet of the liquid tank to an inlet of the infusion tank.

11. The method of claim 10, further comprising the step of:
purging the liquid tank, the infusion tank, the first liquid line and the second liquid line with an inert gas.

12. The method of claim 11, wherein the inert gas is nitrogen.

13. The method of claim 10, wherein the step of directing the liquid from the liquid tank into the infusion tank comprises pumping the liquid through the second liquid line and the step of directing the liquid steep from the infusion tank into the liquid tank comprises pumping the liquid steep through the first liquid line.

14. The method of claim 9, wherein the second period of time is substantially greater than the first period of time.

15. The method of claim 14, wherein the first period of time is from about 10 minutes up to about 15 minutes.

16. The method of claim 14, wherein the second period of time is from about 8 hours up to about 24 hours.
